(19) United States
(12) Patent Application Publication
(10) Pub. No.: US 2011/0058693 A1
(43) Pub. Date: Mar. 10, 2011

(54) WIRELESS MICROPHONE DEVICE

(75) Inventors: Sheng-Hsiung Chang, Taipei County (TW); Sheng-Yuan Chang, Taipei County (TW)

(73) Assignee: TAIWAN GOMET TECHNOLOGY CO., LTD., Taipei County (TW)

(21) Appl. No.: 12/556,471

(22) Filed: Sep. 9, 2009

(51) Int. Cl. H04R 3/00; H04R 19/04

(52) U.S. Cl. 381/122; 381/355

(57) ABSTRACT

The present invention provides a wireless microphone device which comprises a casing, an antenna element and a transceiver. A concave recession is formed on a side surface of the casing. One end of the antenna element is disposed on a bottom surface of the concave recession, and the other end of the antenna element is extending upwardly with an oblique angle relative to the side surface. The transceiver is disposed inside the casing, and transmits or receives a microphone signal by the antenna element. Consequently, according to the present invention, the wireless microphone with the obliquely disposed antenna element can avoid the radio wave from being blocked or absorbed by a user's body, and thereby the efficiency of the antenna element receiving or transmitting the radio wave would not be reduced.

### FIELD OF THE INVENTION

The present invention relates to a wireless microphone device, and more particular to a wireless microphone device having an obliquely disposed antenna element.

### BACKGROUND OF THE INVENTION

Conventional belt pack wireless microphones can be utilized to communicate with others without the necessity of holding the microphone by hands, and thus provides the availability of the hands to perform other tasks. Referring to FIG. 1 for a schematic view of conventional wireless microphone device, the antenna element 110 is usually disposed on the top surface of the casing 120 of the wireless microphone device 100 for receiving or transmitting the radio signal. One end of the antenna element 110 is fixed on the top surface of the casing 120, and the other end is extending upwardly and vertically with a predetermined length.

Referring to FIG. 2 for a diagram of a user wearing the conventional wireless microphone device around the waist, the antenna element 110 might be forced to bend because of the figure of the user. The signal receiving pattern of the antenna element 110 may be changed after the antenna element 110 is bended, thereby decreasing the performance of the antenna element 110. If the bending angle of the antenna element 110 is larger than the designed tolerance or the antenna element 110 is bended repeatedly, the antenna element 110 will be fractured at the mounting point, such that the length of the antenna element 110 becomes different from the original design and the radio wave may not be transmitted or received normally. For other circumstances, the antenna element 110 may be bended toward the user and the top of the antenna element 110 is pressed against the abdomen of the user, resulting in uncomfortable feelings of the user. Moreover, because the antenna element 110 is in close proximity to the user's body, the radio wave may be sheltered or absorbed by the human body, reducing the efficiency of the antenna element 110.

### SUMMARY OF THE INVENTION

In view of the drawbacks of the prior art, a primary object of the present invention is to provide a wireless microphone device for solving the condition that the conventional antenna element is easily bended and fractured by the user's body.

Consequently, the present invention provides a wireless microphone device comprising a casing, an antenna element and a transceiver. A concave recession is formed on a side surface of the casing. One end of the antenna element is disposed on a bottom surface of the concave recession, and the other end of the antenna element is extending upwardly with an oblique angle relative to the side surface. The transceiver is disposed inside the casing for transmitting or receiving a microphone signal via the antenna element.

As described above, the wireless microphone device of the present invention may comprise one or more following advantages:

(1). An oblique angle is formed between the antenna element and the side surface of the wireless microphone device, thereby preventing the antenna element from pressing against the user's body and causing uncomfortable feelings of the user while wearing the wireless microphone device.

(2). Because the antenna element is obliquely disposed on the wireless microphone device, the user's body pressing on the antenna element can be avoided and thus reducing deformation of the antenna element. On the other hand, the obliquely disposed antenna element keeps a distance from the user's body, and thereby the possibility of the radio wave being sheltered or absorbed by the human body is reduced.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic view of the conventional wireless microphone device;

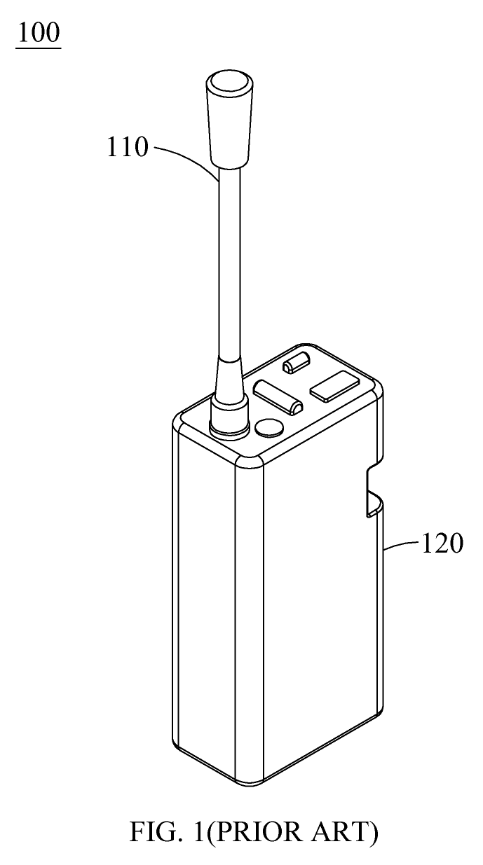

FIG. 2 is a diagram of a user setting the conventional wireless microphone device around the waist;

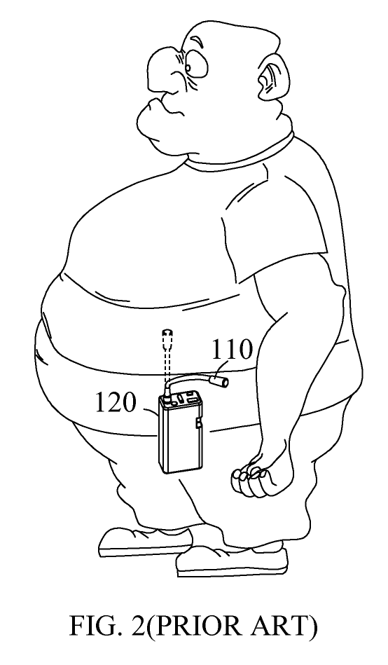

FIG. 3 is a schematic view of the wireless microphone of the present invention;

FIG. 4 is a lateral view of the wireless microphone of the present invention; and

FIG. 5 is a diagram of a user setting the wireless microphone device of the present invention around the waist.

### DETAILED DESCRIPTION OF THE PREFERRED EMBODIMENTS

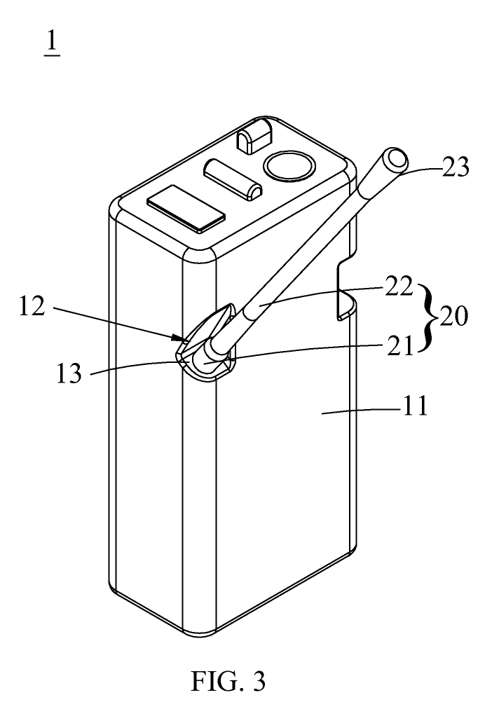

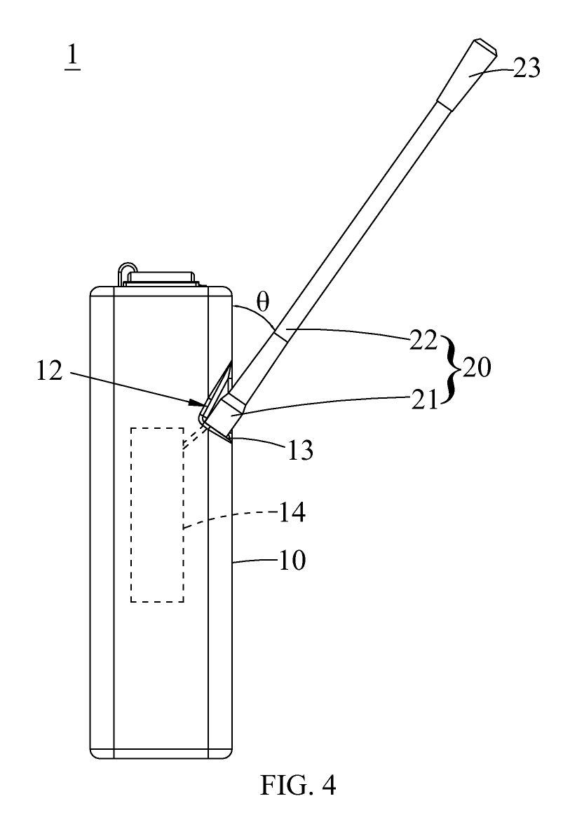

Referring to FIG. 3 and FIG. 4 for a schematic view and a lateral view of the wireless microphone respectively, the wireless microphone device 1 comprises a casing 10 and an antenna element 20. A concave recession 12 is disposed on a side surface 11 of the casing 10. One end of the antenna element 10 is disposed on the bottom surface 13 of the concave recession 12 and the antenna element 10 is extending upwardly with an oblique angle θ relative to the side surface 11. A transceiver 14 is disposed inside the casing, and the transceiver 14 transmits or receives a microphone signal by the antenna element 10.

In addition, the antenna element 20 has a fastening portion 21 and an extending portion 22. The antenna element 20 may be mounted to the casing 10 by latching, screwing or inserting the fastening portion 21 to the bottom surface 13. Other measures may also be taken to fix the fastening portion 21 to the bottom surface 13. Furthermore, one end of the extending portion 22 is connected to the fastening portion 21, and the other end of the extending portion 22 is extending away from the bottom surface 13 as a top end. A cover 23 may further be mounted to cover the top end of the extending portion 22 for protection.

The material of the extending portion 22 may be made of a flexible material or a hard material. The oblique angle θ may be modified according to the actual practice for allowing the user to carry the wireless microphone device 1.

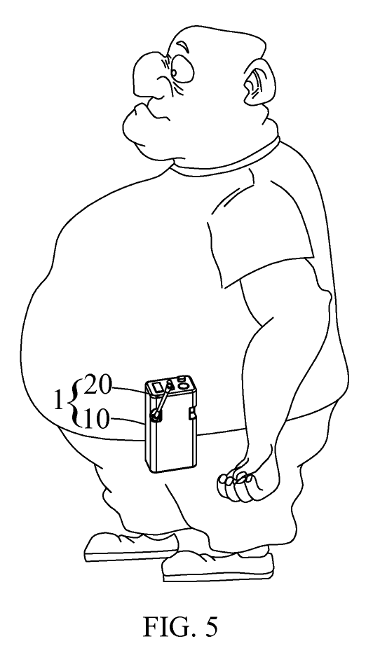

Referring to FIG. 5, when the user wears the wireless microphone device 1 of the present invention around the waist, with the obliquely disposed antenna element 20, the user's body would not press or bend the antenna element 20. Therefore the user would not have any uncomfortable experience, and the performance of the antenna element 20 would not be compromised due to shielding or absorbing of the radio signal.

As described above, the wireless microphone device of the present invention has an obliquely disposed antenna element, so as to avoid the uncomfortable experience of the user because the wireless microphone device would not pressed upon the user's body. Also, the possibility of the decreased efficiency of the antenna element due to sheltered or absorbed radio wave by the human body would be decreased, such that the quality of the communication may be improved.

In addition, the obliquely disposed antenna element on the wireless microphone device of the present invention will prevent the antenna element from being bended by the external force and fractured at the fixed point.

The above description is illustrative only and is not to be considered limited. Various modifications or changes can be made without departing from the spirit and scope of the invention. All such equivalent modifications and changes shall be included within the scope of the appended claims.

What is claimed is:

1. A wireless microphone device comprising:
a casing with a concave recession on a side surface thereof;
an antenna element with one end disposed on a bottom surface of the concave recession and another end extending upwardly with an oblique angle being formed between the antenna element and the side surface; and
a transceiver disposed inside the casing, and the transceiver transmitting or receiving a radio signal of the wireless microphone device by the antenna element.

2. The wireless microphone device as claimed in claim 1, the antenna element comprising:
a fastening portion disposed on the bottom surface; and
an extending portion having one end connecting with the fastening portion, and the other end extending out of the concave recession in a direction away from the bottom surface.

3. The wireless microphone device as claimed in claim 2, wherein the fastening portion is disposed on the bottom surface with one of the methods of latching, screwing or inserting.

4. The wireless microphone device as claimed in claim 2, wherein the extending portion is made of a flexible material or a hard material.
